(19) United States
(12) Patent Application Publication
(10) Pub. No.: US 2025/0077837 A1
(43) Pub. Date: Mar. 6, 2025

(54) ONLINE ESTIMATION METHOD FOR WRIST TORQUE BASED ON NEURAL FEATURES AND LSTM

(71) Applicant: SOUTHEAST UNIVERSITY, Jiangsu (CN)

(72) Inventors: Baoguo XU, Jiangsu (CN); Xinhao YANG, Jiangsu (CN); Zelin GAO, Jiangsu (CN); Aiguo SONG, Jiangsu (CN)

(73) Assignee: SOUTHEAST UNIVERSITY, Jiangsu (CN)

(21) Appl. No.: 18/800,117

(22) Filed: Aug. 11, 2024

Related U.S. Application Data
(63) Continuation of application No. PCT/CN2023/127238, filed on Oct. 27, 2023.

(30) Foreign Application Priority Data
Aug. 28, 2023 (CN) 202311088295.8

(51) Int. Cl. G06N 3/0442; G06F 3/01

(52) U.S. Cl. CPC G06N 3/0442; G06F 3/015

(57) ABSTRACT

Disclosed is an online estimation method for wrist torque based on neural features and LSTM, including following steps: (1) an experimenter keeps his/her arms stationary and applies torque to a torque sensor through his/her wrist; (2) acquiring data from the torque sensor and high-density surface EMG ((HD-sEMG) synchronously; (3) decomposing the HD-sEMG using a blind source separation algorithm to obtain a motor unit spike train (MUST); (4) constructing input and output vectors on the basis of the original HD-sEMG and the decomposed MUST, performing training of the LSTM, and performing polynomial regression of a discharge rate and torque of a neural feature; and (5) calculating a real-time discharge rate (DR) of the CST using a sliding window approach for real-time estimation of the torque.

### CROSS-REFERENCE TO RELATED APPLICATION

This application is a continuation of international application of PCT application serial no. PCT/CN2023/127238, filed on Oct. 27, 2023, which claims the priority benefit of China application no. 202311088295.8, filed on Aug. 28, 2023. The entirety of each of the above-mentioned patent applications is hereby incorporated by reference herein and made a part of this specification.

### TECHNICAL FIELD

The present disclosure belongs to the field of biomechanical and electrical integration, and particularly relates to an online estimation method for wrist torque based on neural features and LSTM.

### BACKGROUND

Electromyography (EMG) is a type of bioelectrical signal in the human body and characterization of skeletal muscle electrical activity. A movement of a human skeleton is completed through muscle contractions, which are always accompanied by the generation of EMG. Therefore, analyzing the EMG can help determine changes in the function of a neuromuscular system. Surface electromyography (sEMG) refers to a muscle electrical signal measured by electrodes on a skin surface, and is generated by a motor unit action potential train (MUAPt) being low-pass filtered through a volume conductor and then transmitted and superimposed on the skin surface. When forming a high-density array, measuring electrodes are capable of measuring multi-channel surface EMG simultaneously, thereby forming high-density surface EMG (HD-sEMG). By using a blind source separation (BSS) algorithm, HD-sEMG can be decomposed into motor unit spike trains (MUST), thereby obtaining deep neural characteristics of muscle electrical activity.

EMG is widely used in the human-machine interaction control, including the realization of natural control over operating force and torque. At present, two main methods are available for torque estimation in robotic arms, prostheses and human-machine interfaces: one is a pattern recognition method based on sEMG, which usually focuses on surface features only, lacks analysis of the mechanism of sEMG generation, and has poor generalization and interpretability; and the other is a calculation method based on a complex skeletal muscle model, featuring intensive computation, and poor timeliness. Therefore, a torque estimation method with clear physiological significance and short computational time is crucial for the real-time control of a prosthetic hand.

### SUMMARY

In order to solve the above problems, the present disclosure provides an online estimation method for wrist torque based on neural features and LSTM, which can be used for natural control and real-time control of a mechanical prosthetic hand, can provide better interaction experience for disabled people, and can also be widely applied to the fields of rehabilitation robots, human-computer interaction, and the like. The present disclosure provides a new control strategy, which considers the neural characteristics of muscle activity, constructs an online torque estimation model through a deep learning method, which can estimate the torque in real time.

In order to achieve the above objectives, the present disclosure adopt the following technical solution:
an online estimation method for wrist torque based on neural features and long short-term memory (LSTM), including following steps:
(1) preparing training data:
before an experiment is started, high-density electrode grids are first attached onto an extensor muscle part and a flexor muscle part of a tested forearm, and the tested forearm then performs specified actions according to an experimental paradigm; surface electromyography (sEMG) is acquired through the high-density electrode grids, and a number of channels is generally selected as 64 channels, 128 channels or 256 channels; at the same time, torque is measured by a torque sensor; and the acquired data are preprocessed for subsequent offline training;
(2) perform a blind source separation to obtain an MUST:
for the preprocessed data, a blind source separation (BSS) algorithm is adopted to obtain each independent motor unit action potential train (MUAPt) and a corresponding separation vector, and a Kmeans clustering algorithm is adopted to identify neuron firings, such that the MUST is obtained, where the MUST is a 0-1 sequence, 0 means that an MU has no action potential at a current moment, and 1 means that the MU is in a discharge state at the current moment.
(3) performing LSTM neural network learning and polynomial regression:
a sequence-to-sequence LSTM classifier is constructed for an original HD-sEMG and decomposed MUSTs; assuming that the high-density electrode grids have M channels, and a blind source separation is performed to obtain N MUSTs, therefore, at each time step, sEMG of the M channels constitutes an M-dimensional input feature vector, and Value of the N MUSTs after being processed at a current time step constitute an N-dimensional output column vector. The input feature vector and the output column vector are adopted to train the LSTM to obtain a neural network capable of identifying whether the MU is issued from the original HD-sEMG.

A cumulative spike train (CST) is obtained after the MUSTs obtained through decomposition are summed up, a number of spikes of the CST are calculated, and an upsampled torque is adopted to perform the polynomial regression to determine a regression polynomial.
(4) Perform online torque estimation by a sliding window approach

For the HD-sEMG acquired online, the M channels each is capable of obtaining sampling data of a new sEMG at each new timestamp, which together constitute an M-dimensional input vector, and an N-dimensional output vector can be obtained after calculation through a LSTM network. A sliding window of 400 ms is selected, the CST is calculated in the sliding window, and wrist torque is estimated in real time through the polynomial regression.

Further, the step (1) also includes:
(1.1) performing filtering: original sEMG is filtered at 20-500 Hz by using a fourth-order Butterworth bandpass filter, and power-line interference in the sEMG is filtered out by using a 50 Hz notch filter; and noise interference in a torque signal is filtered out by using a moving average filter;
(1.2) performing centralization: in an independent component analysis (ICA), each random variable is required to satisfy the requirement that a mean value thereof is zero, and the sEMG needs to be subtracted from the mean value.
(1.3) performing extension: the sEMG xᵢ(n) is modeled as a convolutive mixture model, denoted as follows:

$${x}_{i} ( n ) = {\sum }_{j = 1}^{N} {\sum }_{i = 0}^{L - 1} {a}_{ij} ( l ) {t}_{j} ( n - 1 ) + {w}_{i} ( n ) : i = 1 , … , M$$

where wᵢ(n) represents a random noise; Σᵢ₌₀^{L-1}aᵢⱼ(l) represents a waveform of a j^{th} MUAP in an i^{th} channel, and a length of the waveform is L; tⱼ(n) represents a discharge timing of a j^{th} MU, and a value thereof is 0 or 1, which can be expressed by a unit pulse function δ, tⱼ(n)=Σₖδ(n−Tⱼ(k)), that is, when the j^{th} MU is activated at a Tⱼ(k) moment, tⱼ(Tⱼ(k))=1.

After the sEMG of the M channels is extended, the convolutive mixture model of the sEMG can be expressed as a linear instantaneous mixture model. An observation matrix before extension consists of the sEMG of the M channels, which can be expressed as X=[x₁(n), x₂(n), . . . , x_{M}(n)]^{T}; and a matrix after extension is expressed as

$$\overline{X} = {[ {x}_{1} ( n ) , {x}_{1} ( n - 1 ) , … , {x}_{1} ( n - R + 1 ) , … , {x}_{M} ( n ) , … , {x}_{M} ( n ) ( n - R + 1 ) ]}^{T} .$$

(1.4) Whitening: whitening is performed to decorrelate a source signal and reduce redundancy of data input. Eigenvalue decomposition is performed on a covariance matrix Σ of an extension matrix X̅: Σ=UΛU^{T}, where U represents an orthogonal matrix, Λ represents an eigenvalue matrix, and W=UΛ^{-1/2}U^{T} represents a whitening matrix. The whitening matrix W is multiplied by X̅ to obtain a whitened matrix Z.

Further, the step (2) also includes:
(2.1) obtaining a separation vector w by a fixed point iteration method: assuming that a contrast function for measuring sparseness of the source signal is G(x), where when a first-order derivative is g(x), and an iteration equation of the w is:

$$w ( n ) = E \{ Zg [ {w ( n - 1 )}^{T} Z ] \} - Aw ( n - 1 ) , where A = E \{ {g}^{′} [ {{w}_{i} ( n - 1 )}^{T} Z ] \} .$$

Orthogonalization and normalization are performed on w(n) to ensure that the separated source signal has no repeated signal;
(2.2) improving the separation vector: a separation vector w(n) is multiplied by a whitened matrix Z to obtain the source signal, which is subjected to binary clustering to obtain the MUST. Sparseness of the MUST is measured through a pulse interval variation coefficient (CoVof ISI), a spareness value should be as small as possible, and the separation vector is iterated again by taking the sparseness value as a convergence target, with an iteration equation being

$$w ( n + 1 ) = \frac{1}{K} {\sum }_{k = 1}^{K} Z ( {t}_{k} ) ,$$

where K represents a number of values that are 1 in the MUST, and tₖ represents a moment of values that are 1 in the MUST; and
(2.3) verifying the separation vector: the separation vector after being processed in steps (2.1) and (2.2) is verified to improve the reliability of separation results. The reliability of the separation results is measured through three parameters, that is, pulse to noise ratio (PNR), Silhouette distance (SIL) and minimum inter-spike interval (MISI). The three parameters evaluate the reliability of the separated source signal from three aspects, that is, signal-to-noise ratio, clustering effect and whether a neural discharge principle is satisfied, with calculation formulae thereof as follows:

$$PNR ( j ) = 10 \cdot log ( \frac{E ( x \vert {t}_{j} ( n ) = 1 )}{E ( x \vert {t}_{j} ( n ) = 0} )$$

$$SIL = \frac{b - a}{max ( a , b )}$$

$$MISI = min ( ISI )$$

in the calculation formula of PNR, j represents a j^{th} MU; in the calculation formula of SIL, b represents a sum of intercluster distances among clusters, a represents a sum of intracluster distances among the clusters; and ISI represents a pulse interval.

Further, the step (3) also includes:
(3.1) constructing an input vector: sEMG values of all the channels at a certain moment constitute an input column vector I(n)=[x₁(n), x₂(n), . . . , x_{M}(n)]^{T}ϵQ^{M};
(3.2) constructing an output vector: values of all the MUSTs at the current moment constitute an N-dimensional column vector, and an element of the vector is 0 or 1; and however, a value of 1 in the vector indicates that a MUAP spike is present at the current moment, and the MU with a value of 0 does not mean that it is not activated, an MU with a value of 0 does not necessarily mean that it is not activated; it is possible that the MU is activated and still generates an action potential, but a spike of the action potential is simply not at the current moment. Therefore, the MUSTs need to be modified to serve as an output vector of the LSTM. Considering that a general waveform length of the MUAP is 90 ms, the present disclosure expands the 1 in the MUST, and values in a first 45 ms and a last 45 ms are all assigned to 1 from 0, and the modified MUSTs at the current moment are regarded as sampling points to form the N-dimensional column vector On).

Since the MUAP waveforms overlap, a plurality of the values of 1 may exist in the vector O(n), making the output of the LSTM unable to meet one-hot encoding. In order to improve recognition performance of the LSTM, distances between different o(n) are made equal by using Schmitt orthogonalization. Assuming that O(n) has a total of P types of different values, which form a matrix O=[o₁, . . . , oₚ], and the O is subjected to UT decomposition to obtain:

$$O = [ {o}_{1} , … , {o}_{p} ] = UT = [ {η}_{1} , … , {η}_{p} ] [ \begin{matrix}{β}_{1} \\ ⋮ \\ {β}_{p}\end{matrix} ]$$

where a column vector in the matrix U satisfies orthogonalization and unitization; the vector O(n) is replaced by a corresponding η and taken as an output vector of the LSTM, denoted as õ(n); and
(3.3) constructing the neural network: the neural network includes an input layer, an LSTM layer, a Batch Normalization layer, a Dropout layer, a Fully Connected layer, a Softmax layer, and an output layer. A size of the input layer is a number of channels M, and a size of the output layer is N, and training is performed based on a (I(n), Õ(n)) data set.

Further, the step (4) also includes:
(4.1) since the orthogonalization and normalization are performed in the step (3.2), O(n) needs to be reversely solved for the output vector calculated by the LSTM according to an equation decomposed through UT;
(4.2) since is in the MUSTs are extended, when a series of is are identified, indicating that MUAP waveforms are present at these time points, however, only 1 in a middle position is required when the neural features are calculated, therefore, other is need to be reassigned as 0; and
(4.3) in the sliding window, a new column vector O(n_{new}) is added, an old column vector O(n_{old}) is removed, all the MUSTs are summed up to obtain the CST, the CST in the window is subjected to a pulse count, and a value obtained is inputted to a polynomial regression equation as an independent variable to obtain a real-time estimation of the torque.

The present disclosure has the beneficial effects:
1. For the method for estimating the wrist torque, the present disclosure directly establishes the relationship between neural features and torque. Compared with time-frequency domain features of sEMG, the neural features are more stable, have clearer significance and higher robustness when being used for torque estimation. Therefore, the method has greater advantages in natural control of prostheses and robotic arms.
2. The present disclosure gives special consideration to the output vector, making it possible to train the LSTM neural network under sparse pulse sequences by extending is in the MUSTs. As long as the acquired HD-sEMG contains waveform information, LSTM can identify MU activation and then extract neural features. At the same time, in order to improve the classification performance of LSTM, the present disclosure can orthogonalize and normalize a column vector of the cross-section intercepted from the MUSTs, enabling distances among different vectors to be equal to meet the training requirements of the LSTM. The present disclosure effectively combines the characteristics of MUST with LSTM through special processing of the output vector, such that effective estimation can be obtained.
3. In the iterative process of separating vectors, the present disclosure verifies the separation vectors from three aspects: that is, signal-to-noise ratio, clustering effect and physiological considerations, to ensure that the results obtained by the blind source separation algorithm are accurate and reliable.
4. The present disclosure provides a method for estimating torque online by a sliding window approach, which is based on LSTM and the neural feature CST. To achieve real-time online estimation, the calculation latency should be small, and the sliding window CST counting method provided in the present disclosure can meet the requirement for low latency. When the window length is fixed, each new HD-sEMG sample results in a new input vector, which is inputted into a trained LSTM network, enabling rapid calculation of predicted MUSTs column vectors through the above steps. The sliding window acts like a stack, where the newly-predicted MUSTs column vector enters the sliding window and squeezes out the earliest vector in the window. By accumulating the MUSTs in the sliding window, CST neural features are obtained, and a number of the CST pulses in the sliding window is calculated to estimate the torque. The entire process involves simple calculation, and can achieve continuous online real-time estimation.

### BRIEF DESCRIPTION OF THE DRAWINGS

FIG. 1 is a flowchart of an online estimation method for wrist torque based on neural features and LSTM according to the present disclosure.

FIG. 2 is a flowchart of a blind source separation algorithm according to the present disclosure.

FIG. 3 is a schematic diagram of LSTM training according to the present disclosure.

FIG. 4 is a schematic diagram of constructing an output vector according to the present disclosure.

FIG. 5 is a schematic diagram of online torque estimation by a sliding window approach according to the present disclosure.

### DETAILED DESCRIPTIONS OF THE EMBODIMENTS

The present disclosure will be further illustrated below with reference to the accompanying drawings and specific embodiments. It should be understood that the following specific embodiments are only used to illustrate the present disclosure, but are not intended to limit the scope of the present disclosure.

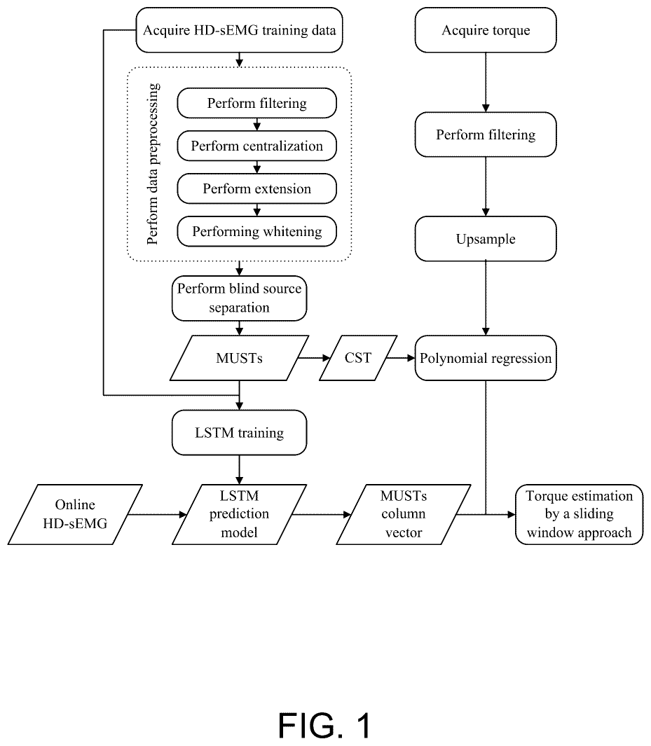

As shown in FIG. 1, the present disclosure provides an online estimation method for wrist torque based on neural features and LSTM, specifically including following steps:
Step (1) preparing training data:
before an experiment is started, high-density electrode grids are first attached onto an extensor muscle part and a flexor muscle part of a tested forearm, and the tested forearm then performs specified actions according to an experimental paradigm; and after the experiment is started, surface electromyography (sEMG) and torque are acquired through the high-density electrode grids and a torque sensor, and the acquired data are preprocessed for subsequent offline training.

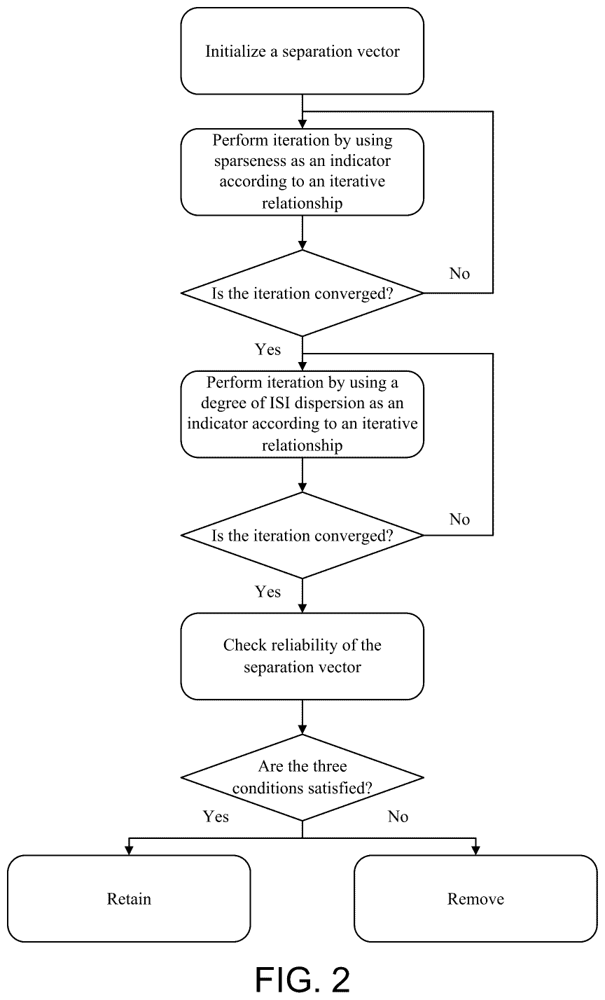

Specifically, the data processing includes the following sub-steps:
(a) performing filtering: original sEMG is filtered at 20-500 Hz by using a fourth-order Butterworth bandpass filter, and power-line interference in the sEMG is filtered out by using a 50 Hz notch filter; and noise interference in a torque signal is filtered out by using a moving average filter;
(b) performing centralization: the sEMG is subtracted from its mean value to satisfy the requirement that the mean value of all random variables in ICA is 0;
(c) performing extension: the sEMG xᵢ(n) is modeled as a convolutive mixture model, denoted as follows:

$${x}_{i} ( n ) = {\sum }_{j = 1}^{N} {\sum }_{i = 0}^{L - 1} {a}_{ij} ( t ) {t}_{j} ( n - l ) + {w}_{i} ( n ) ; i = 1 , … , M$$

where wᵢ(n) represents a random noise; Σᵢ₌₀^{L-1}aᵢⱼ(l) represents a waveform of a j^{th} MUAP in an i^{th} channel, and a length of the waveform is L; tⱼ(n) represents a discharge timing of a j^{th} MU, and a value thereof is 0 or 1, which can be expressed by a unit pulse function δ, that is tⱼ(n)=Σₖδ(n−Tⱼ(k)), when the j^{th} MU is activated at a moment Tⱼ(k), tⱼ(Tⱼ(k))=1;
an observation matrix before extension consists of the sEMG of the M channels, which can be expressed as X=[x₁(n), x₂(n), . . . , x_{M}(n)]^{T}; and after the sEMG of the M channels is extended, a matrix after extension is expressed as X̅=[x₁(n), x₁(n−1), . . . , x₁(n−R+1), . . . , x_{M}(n−R+1)]^{T}; and
(d) performing whitening: eigenvalue decomposition is performed on a covariance matrix Σ of an extension matrix X̅: Σ=UΛU^{T}, where U represents an orthogonal matrix, A represents an eigenvalue matrix, and W=UΛ^{-1/2}U^{T} represents a whitening matrix. The whitening matrix W is multiplied by X̅ to obtain a whitened matrix Z.
Step (2) performing a blind source separation to obtain an MUST:
after Z is obtained, Z is decomposed by using a blind source separation (BSS) algorithm to obtain each independent MUAPt and a corresponding separation vector. Binary clustering is performed using a Kmeans clustering algorithm to identify neuron firings, such that a 0-1 sequence MUST is obtained, and an algorithm flow chart is shown in FIG. 2. 1 in the MUST represents that MU is in a discharge state at the current moment.

Specifically, the step (2) includes the following sub-steps:
(a) obtaining a separation vector w by a fixed point iteration method: assuming that a contrast function for measuring sparseness of a source signal is G(x), where when a first-order derivative is g(x), and an iteration equation of the w is:

$$w ( n ) = E \{ Zg [ w {( n - 1 )}^{T} Z ] \} - Aw ( n - 1 ) , where A = E \{ {g}^{′} [ {w}_{i} {( n - 1 )}^{T} Z ] \} .$$

Orthogonalization and normalization are performed on w(n) to ensure that separated source signals have no repeating signals;
(b) improving the separation vector: a separation vector w(n) is multiplied by a whitened matrix Z to obtain the source signal, which is subjected to binary clustering to obtain the MUST. Sparseness of the MUST is measured through a pulse interval variation coefficient, a spareness value should be as small as possible, and the separation vector is iterated again by taking the sparseness value as a convergence target, with an iteration equation being

$$w ( n + 1 ) = \frac{1}{K} {\sum }_{k = 1}^{K} Z ( {t}_{k} ) ,$$

where K represents a number of values that are 1 in the MUST, and tₖ represents a moment of values that are 1 in the MUST.
(c) verifying the separation vector: the separation vector after being processed in the steps (a) and (b) is verified to improve the reliability of separation results. The reliability of the separation results is measured through three parameters, that is, PNR, SIL, and MISI. The three parameters evaluate the reliability of the separated source signal from three aspects, that is, signal-to-noise ratio, clustering effect and whether a neural discharge principle is satisfied, with calculation formulae thereof as follows:

$$PNR ( j ) = 10 \cdot log ( \frac{E ( x \vert {t}_{j} ( n ) = 1 )}{E ( x \vert {t}_{j} ( n ) = 0} )$$

$$SIL = \frac{b - a}{max ( a , b )}$$

$$MISI = min ( ISI )$$

in the calculation formula of PNR, j represents a j^{th} MU; in the calculation formula of SIL, b represents a sum of intercluster distances among clusters, a represents a sum of intracluster distances among the clusters; and ISI represents a pulse interval.
Step (3) performing LSTM neural network learning and polynomial regression:

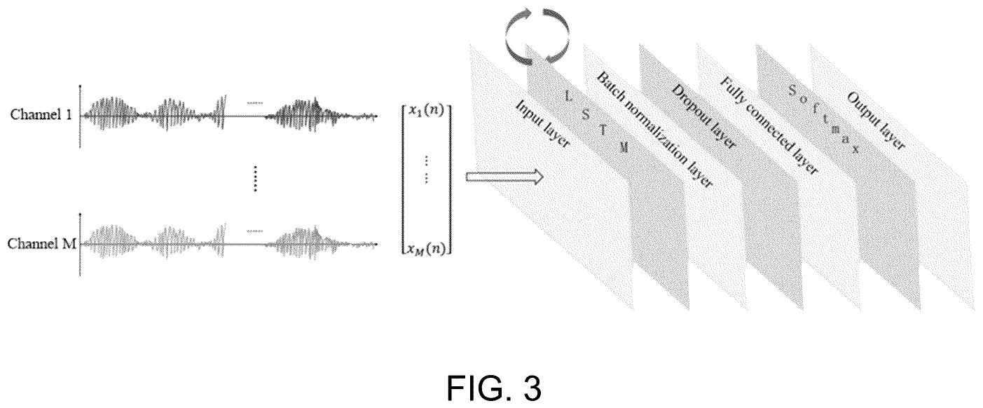

A sequence-to-sequence LSTM classifier is constructed for an original HD-sEMG and decomposed MUSTs, as shown in FIG. 3. Assuming that the high-density electrode grids have M channels, and a blind source separation is performed to obtain N MUSTs, therefore, at each time step, sEMG of the M channels constitutes an M-dimensional input feature vector, and values of the N MUSTs after being processed at a current time step constitute an N-dimensional output column vector. The input feature vector and the output column vector are adopted to train the LSTM.

A cumulative spike train (CST) is obtained after the MUSTs obtained through decomposition are summed up, a number of spikes of the CST are calculated, and an upsampled torque is adopted to perform the polynomial regression to determine a regression polynomial.

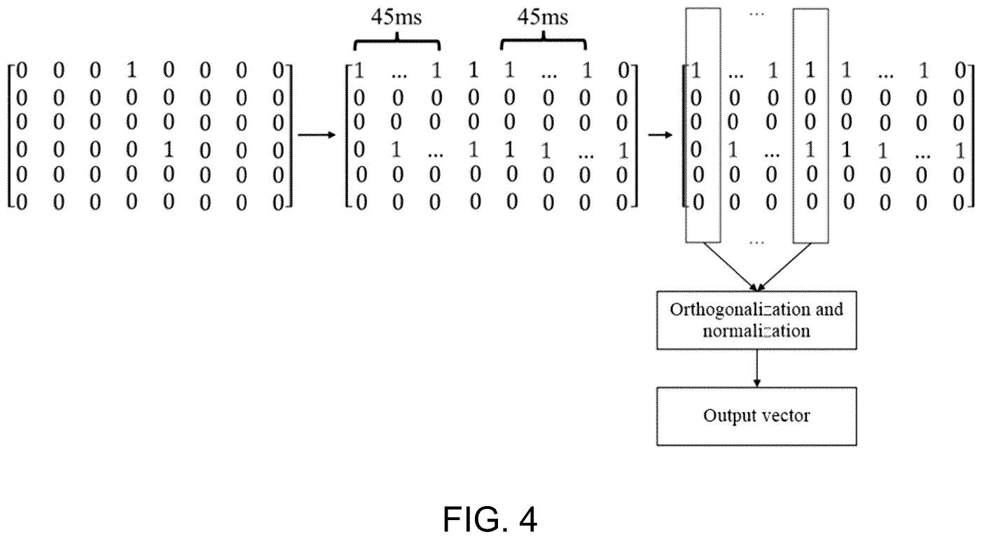

Specifically, the LSTM training step includes:
(a) constructing an input vector: sEMG values of all the channels at a certain moment constitute an input column vector I(n)=[x₁(n), x₂(n), . . . , x_{M}(n)]^{T}ϵQ^{M}, as shown in FIG. 3.
(b) constructing an output vector: as shown in FIG. 4, values of all the MUSTs at the current moment constitute an N-dimensional column vector, and an element of the vector is 0 or 1. In particular, considering that a general waveform length of the MUAP is 90 ms, the present disclosure expands the 1 in the MUST, and values in a first 45 ms and a last 45 ms are all assigned to 1 from 0, and the modified MUSTs at the current moment are regarded as sampling points to form the N-dimensional column vector O(n).

In order to organically combine characteristics of the MUST with the LSTM, distances between different o(n) are made equal by using Schmitt orthogonalization, such that the LSTM obtains better recognition performance. Assuming that O(n) has a total of p types of different values, which form a matrix O=[o₁, . . . , oₚ] and the O is subjected to UT decomposition to obtain:

$$O = [ {o}_{1} , … , {o}_{p} ] = UT = [ {η}_{1} , … , {η}_{p} ] [ \begin{matrix}{β}_{1} \\ ⋮ \\ {β}_{p}\end{matrix} ]$$

where a column vector in the matrix U satisfies orthogonalization and unitization; and the vector O(n) is replaced by a corresponding η and taken as an output vector of the LSTM, denoted as õ(n).
(c) constructing the neural network: the neural network includes an input layer, an LSTM layer, a Batch Normalization layer, a Dropout layer, a Fully Connected layer, a Softmax layer, and an output layer, with a structure shown in FIG. 3. A size of the input layer is a number of channels M, and a size of the output layer is N, and training is performed based on a (I(n), õ(n)) data set.
Step (4) performing online torque estimation by a sliding window approach

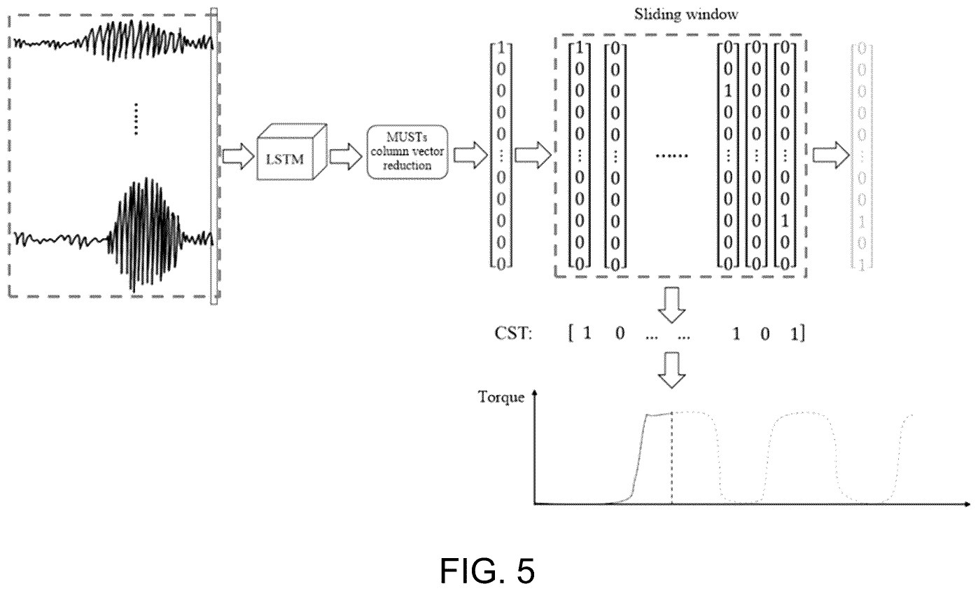

A method for estimating the torque online by the sliding window is shown in FIG. 5. For the HD-sEMG acquired online, the M channels each is capable of obtaining sampling data of a new sEMG at each new timestamp, which together constitute an M-dimensional input vector, and an N-dimensional output vector can be obtained after calculation through a LSTM network. A sliding window of 400 ms is selected, the MUSTs are accumulated to obtain a CST, a number of spikes of the CST is calculated, and wrist torque is estimated in real time through the polynomial regression.

Specifically, the step (4) includes the following sub-steps:
(a) since the orthogonalization and normalization are performed in the step (3.2), O(n) needs to be reversely solved for the output vector calculated by the LSTM according to an equation decomposed through UT;
(b) since is in the MUSTs are extended, when a series of is are identified, indicating that MUAP waveforms are present at these time points, however, only 1 in a middle position is required when the neural features are calculated, therefore, other is need to be reassigned as 0; and
(c) in the sliding window, a new column vector O(n_{new}) is added, an old column vector O(n_{old}) is removed, all the MUSTs are summed up to obtain a CST, the CST in the window is subjected to a pulse count, and a value obtained is inputted to a polynomial regression equation as an independent variable to obtain a real-time estimation of the torque.

What is claimed is:

1. An online estimation method for wrist torque based on neural features and LSTM, specifically comprising following steps:
(1) preparing training data:
before an experiment is started, high-density electrode grids are first attached onto an extensor muscle part and a flexor muscle part of a tested forearm, and the tested forearm then performs specified actions according to an experimental paradigm; surface electromyography (sEMG) is acquired through the high-density electrode grids, and a number of channels is generally 64 channels, 128 channels or 256 channels; at the same time, torque is measured by a torque sensor; and acquired data are preprocessed for subsequent offline training;
(2) performing a blind source separation to obtain an MUST:
for the preprocessed data, a blind source separation (BSS) algorithm is adopted to obtain each independent motor unit action potential train (MUAPt) and a corresponding separation vector, and a Kmeans clustering algorithm is adopted to identify neuron firings, such that the MUST is obtained; and the MUST is a 0-1 sequence, 0 means that an MU has no action potential at a current moment, and 1 means that the MU is in a discharge state at the current moment;
(3) performing long short-term memory (LSTM) neural network learning and polynomial regression:
a sequence-to-sequence LSTM classifier is constructed for an original HD-sEMG and decomposed MUSTs; assuming that the high-density electrode grids have M channels, and a blind source separation is performed to obtain N MUSTs, therefore, at each time step, sEMG of the M channels constitute an M-dimensional input feature vector, and values of the N MUST after being processed at a current time step constitute an N-dimensional output column vector; and the M-dimensional input feature vector and the N-dimensional output column vector are adopted to train the sequence-to-sequence LSTM classifier to obtain a neural network capable of identifying whether the MU is issued from the original HD-sEMG;
a cumulative spike train (CST) is obtained after the MUSTs obtained through decomposition are summed up, a number of spikes of the CST are calculated, and an upsampled torque is adopted to perform the polynomial regression to determine a regression polynomial; and
(4) performing online torque estimation by a sliding window approach:
for a HD-sEMG acquired online, the M channels each is capable of obtaining sampling data of a new sEMG at each new timestamp, which together constitute an M-dimensional input vector, and an N-dimensional output vector can be obtained after calculation through the sequence-to-sequence LSTM classifier; and a sliding window of 400 ms is selected, the CST is calculated in the sliding window, and wrist torque is estimated in real time through the regression polynomial.

2. The online estimation method for wrist torque based on neural features and LSTM according to claim 1, wherein the step (1) comprises:
step (1.1) performing filtering: for the sEGM, the sEMG is filtered at 20-500 Hz by using a fourth-order Butterworth bandpass filter, and power-line interference in the sEMG is filtered out by using a 50 Hz notch filter; and noise interference in a torque signal is filtered out by using a moving average filter;
step (1.2) performing centralization: in an independent component analysis (ICA), each random variable is required to satisfy requirement that a mean value thereof is zero, and the mean value needs to be subtracted from the sEMG;
step (1.3) performing extension: the sEMG xᵢ(n) is modeled as a convolutive mixture model, denoted as follows:
$${x}_{i} ( n ) = {\sum }_{j = 1}^{N} {\sum }_{i = 0}^{L - 1} {a}_{ij} ( t ) {t}_{j} ( n - l ) + {w}_{i} ( n ) ; i = 1 , … , M$$
where wᵢ(n) represents a random noise; Σᵢ₌₀^{L-1}aᵢⱼ(l) represents a waveform of a j^{th} MUAP in an i^{th} channel, and a length of the waveform is L; tⱼ(n) represents a discharge timing of a j^{th} MU, and a value thereof is 0 or 1, which can be expressed by a unit pulse function δ: tⱼ(n)=Σₖδ(n−Tⱼ(k)), that is, when the j^{th} MU is activated at a Tⱼ(k) moment,
$${t}_{j} ( {T}_{j} ( k ) ) = 1 ;$$
after the sEMG of the M channels is extended, the convolutive mixture model of the sEMG can be expressed as a linear instantaneous mixture model; an observation matrix before extension consists of the sEMG of the A channels, which can be expressed as X=[x₁(n), x₂(n), . . . , x_{M}(n)]^{T}; and a matrix after extension is expressed as
$$\overline{X} = {[ {x}_{1} ( n ) , {x}_{1} ( n - 1 ) , … , {x}_{1} ( n - R + 1 ) , … , {x}_{M} ( n ) , … , {x}_{M} ( n - R + 1 ) ]}^{T} ;$$
step (1.4) performing whitening: whitening is performed to decorrelate a source signal and reduce redundancy of data input; and eigenvalue decomposition is performed on a covariance matrix E of an extension matrix X̅: Σ=UΛU^{T}, wherein U represents an orthogonal matrix, A represents an eigenvalue matrix, and W=UΛ^{-1/2}U^{T} represents a whitening matrix; and the whitening matrix W is multiplied by X̅ to obtain a whitened matrix Z.

3. The online estimation method for wrist torque based on neural features and LSTM according to claim 2, wherein the step (2) comprises:
step (2.1) obtaining a separation vector w by a fixed point iteration method: assuming that a contrast function for measuring sparseness of the source signal is G(x), wherein when a first-order derivative is g(x), and an iteration equation of the separation vector w is:
$$w ( n ) = E \{ Zg [ w {( n - 1 )}^{T} Z ] \} - Aw ( n - 1 ) , wherein A = E \{ {g}^{′} [ {w}_{i} {( n - 1 )}^{T} Z ] \} ;$$
and orthogonalization and normalization are performed on w(n) to ensure that separated source signals have no repeating signals;
step (2.2) improving the separation vector: the separation vector w(n) is multiplied by the whitened matrix Z to obtain the source signal, which is subjected to binary clustering to obtain the MUST; and sparseness of the MUST is measured through a pulse interval variation coefficient, a sparseness value should be as small as possible, and the separation vector w(n) is iterated again by taking the sparseness value as a convergence target, with an iteration equation being
$$w ( n + 1 ) = \frac{1}{K} {\sum }_{k = 1}^{K} Z ( {t}_{k} ) ,$$
wherein K represents a number of values that are 1 in the MUST, and tₖ represents a moment of values that are 1 in the MUST; and
step (2.3) verifying the separation vector: the separation vector after being processed in the steps (2.1) and (2.2) is verified to improve the reliability of separation results; the reliability of a separation result is measured through three parameters, that is, PNR, SIL, and MISI; and the three parameters evaluate the reliability of the separated source signals from three aspects, that is, signal-to-noise ratio, clustering effect and whether a neural discharge principle is satisfied, with calculation formulae thereof as follows:
$$PNR ( j ) = 10 \cdot log ( \frac{E ( x \vert {t}_{j} ( n ) = 1 )}{E ( x \vert {t}_{j} ( n ) = 0} )$$
$$SIL = \frac{b - a}{max ( a , b )}$$
$$MISI = min ( ISI )$$
in the calculation formula of PNR, j represents a j^{th} MU; in the calculation formula of SIL, b represents a sum of intercluster distances among clusters, a represents a sum of intracluster distances among the clusters; and ISI represents a pulse interval.

4. The online estimation method for wrist torque based on neural features and LSTM according to claim 1, wherein the step (3) comprises:
step (3.1) constructing an input vector: sEMG values of all the channels at a certain moment constitute an input column vector I(n)=[x₁(n), x₂(n), . . . , x_{M}(n)]^{T}ϵQ^{M};
step (3.2) constructing an output vector: values of all the MUSTs at the current moment constitute an N-dimensional column vector, and an element of the N-dimensional column vector is 0 or 1; and however, a value of 1 in the N-dimensional column vector indicates that a MUAP spike is present at the current moment, and an MU with a value of 0 does not necessarily mean that it is not activated, and it is possible that the MU is activated and still generates an action potential, but a spike of the action potential is simply not at the current moment; therefore, the MUSTs need to be modified to serve as an output vector of the LSTM; considering that a general waveform length of the MUAP is 90 ms, values of 1 in the MUST are expanded, and values in a first 45 ms and a last 45 ms are all assigned to 1 from 0, and the modified MUSTs at the current moment are regarded as sampling points to form an N-dimensional column vector O(n);
since the MUAP waveforms overlap, a plurality of the values of 1 may exist in the N-dimensional column vector O(n), making the output of the LSTM unable to meet one-hot encoding; in order to improve recognition performance of the LSTM, distances between different O(n) are made equal by using Schmitt orthogonalization; and assuming that O(n) has a total of P types of different values, which form a matrix O=[o₁, . . . , oₚ], and the O is subjected to UT decomposition to obtain:
$$O = [ {o}_{1} , … , {o}_{p} ] = UT = [ {η}_{1} , … , {η}_{p} ] [ \begin{matrix}{β}_{1} \\ ⋮ \\ {β}_{p}\end{matrix} ]$$
where a column vector in the matrix U satisfies orthogonalization and unitization; and the vector O(n) is replaced by a corresponding η and taken as an output vector of the LSTM, denoted as Õ(n); and
step (3.3) constructing the neural network: the neural network comprises an input layer, an LSTM layer, a Batch Normalization layer, a Dropout layer, a Fully Connected layer, a Softmax layer, and an output layer; and a size of the input layer is M, and a size of the output layer is N, and training is performed based on a (I(n), Õ(n)) data set.

5. The online estimation method for wrist torque based on neural features and LSTM according to claim 4, wherein the step (4) comprises:
step (4.1) since the orthogonalization and normalization are performed in the step (3.2), O(n) needs to be reversely solved for the output vector calculated by the LSTM according to an equation decomposed through UT;
step (4.2) since is in the MUSTs are extended, when a series of is are identified, indicating that MUAP waveforms are present at these time points, however, only 1 in a middle position is required when the neural features are calculated, therefore, other is need to be reassigned as 0; and
step (4.3) in the sliding window, a new column vector O(n_{new}) is added, an old column vector O(n_{old}) is removed, all the MUSTs are summed up to obtain the CST, the CST in the window is subjected to a pulse count, and a value obtained is inputted to a polynomial regression equation as an independent variable to obtain a real-time estimation of the torque.
